(19) United States
(12) Patent Application Publication
(10) Pub. No.: US 2013/0157841 A1
(43) Pub. Date: Jun. 20, 2013

(54) METHODS FOR PREPARING INTEGRAL CATALYSTS WHILE MAINTAINING ZEOLITE ACIDITY AND CATALYSTS MADE THEREBY

(71) Applicants: Howard S. Lacheen, Richmond, CA (US); Robert J. Saxton, Pleasanton, CA (US)

(72) Inventors: Howard S. Lacheen, Richmond, CA (US); Robert J. Saxton, Pleasanton, CA (US)

(73) Assignee: CHEVRON U.S.A. Inc., San Ramon, CA (US)

(21) Appl. No.: 13/327,233

(22) Filed: Dec. 15, 2011

(51) Int. Cl. B01J 37/30; B01J 35/02

(52) U.S. Cl. 502/74; 502/60; 502/85

(57) ABSTRACT

Methods for preparing catalysts including a transition metal component and a zeolite component are disclosed. In some embodiments, the transition metal is deposited in a precursor solution onto a zeolite extrudate to form an intermediate integral catalyst wherein prior to the deposition, the zeolite has been subjected to an initial ion exchange with protecting cations which exchange with the protons of the zeolite. The intermediate integral catalyst is heated to decompose the transition metal, and the catalyst is subsequently subjected to a secondary ion exchange with an ionic ammonium complex which exchanges with the protecting cations. The resulting ammonium treated catalyst is heated to a temperature sufficient to decompose the ammonium complex to form ammonia and H⁺ ions. The transition metal in the resulting catalyst is in the form of reduced crystallites located outside the zeolite channels. No appreciable ion exchange of the transition metal occurs within the zeolite channels.

### BACKGROUND

The present disclosure relates to methods for the preparation of catalysts containing a catalytically active transition metal component and an acidic zeolite component and further relates to catalysts prepared by the methods. More particularly, the present disclosure relates to methods for the preparation of catalysts which avoid ion exchange of the transition metal component with the ions within the channels of the acidic zeolite component.

Bifunctional catalysts prepared by depositing at least one catalytically active transition metal component onto an acidic component such as a zeolite are known for use in catalytic processes including, for example, synthesis gas conversion and hydrotreating. Such uses may benefit from the acid function of the zeolite. For instance, the acid component may catalyze skeletal isomerization, cracking and alkylation reactions.

Fischer-Tropsch (FT) catalysts and their preparation methods are known. FT catalysts are typically based on Group 8-10 metals such as, for example, iron, cobalt, nickel and ruthenium, also referred to herein as “FT components,” “FT active metals” or simply “FT metals,” with iron and cobalt being the most common. The product distribution over such catalysts is non-selective and is generally governed by the Anderson-Schulz-Flory (ASF) polymerization kinetics. Recent developments have led to so-called “hybrid FT” or “integral FT” catalysts having improved properties involving an FT component bound on an acidic component, typically a zeolite component. The catalytic functionality of hybrid or integral FT catalysts allows conversion of synthesis gas to desired liquid hydrocarbon products by minimizing product chain growth, thus precluding the need for further hydrocracking to obtain desired products. Thus, the combination of an FT component displaying high selectivity to short-chain a-olefins and oxygenates with zeolite(s) results in an enhanced selectivity for pourable, wax free liquid products by promoting oligomerization, cracking, isomerization, and/or aromatization reactions on the zeolite acid sites. Hybrid or integral FT catalysts for the conversion of synthesis gas to liquid hydrocarbons have been described, for example, in co-pending U.S. patent application Ser. No. 12/343,534 and U.S. Pat. No. 7,943,674 issued May, 17, 2011 (Kibby et al.), which are herein incorporated by reference.

Hybrid or integral FT catalysts are typically prepared by wet impregnation methods using aqueous or non-aqueous solutions of metal salts. During the course of this impregnation and the resultant drying and calcination, a portion of the FT metal ions (cations) migrate into the zeolite channels and essentially titrate the acid sites through ion exchange with protons in the zeolite channels. Ion exchange of the FT metal for protons within the zeolite has two disadvantages. First, zeolite acidity necessary to crack or isomerize FT olefins and to avoid making a solid wax component is neutralized. Second, ion-exchanged FT metal is non-reducible by virtue of strong metal-support interactions thus decreasing the activity of the catalyst and the overall productivity of the FT reaction. For cobalt FT metal, the ion exchange sites are quite stable positions and cobalt ions in these positions are not readily reduced during normal activation procedures. The reduction in the amount of reducible cobalt decreases the activity of the FT component in the catalyst.

A method is needed to prepare a bifunctional catalyst in which a metal is deposited onto a zeolite surface while minimizing ion exchange of metal cations with protons within the zeolite channels, such that both the zeolite acid capacity and metal activity are maintained.

### SUMMARY

In one aspect, a method is provided for preparing a catalyst which includes the steps of conducting ion exchange of a zeolite with an ammonium cation to form an ion exchanged zeolite, depositing a catalytically active component comprising a transition metal onto the ion exchanged zeolite to form an intermediate integral catalyst, and heating the intermediate integral catalyst at sufficient temperature to decompose the catalytically active component and generate the H⁺ form of the zeolite.

In another aspect, a method is provided for preparing a catalyst which includes the steps of conducting initial ion exchange of a zeolite with a cation selected from the group consisting of Na, K, Ca, Li, Rb, Be, Mg, Sr, Ca, Ba and ammonium ions and mixtures thereof to form an ion exchanged zeolite, depositing a catalytically active component comprising a transition metal onto the ion exchanged zeolite to form an intermediate integral catalyst, and heating the intermediate integral catalyst at sufficient temperature to decompose the catalytically active component. The method further includes conducting secondary ion exchange of the intermediate integral catalyst with ammonium to form an ammonium treated catalyst wherein ammonium ions exchange with the cation of the ion exchanged zeolite, and heating the ammonium treated catalyst at sufficient temperature to decompose the ammonium to ammonia and generate the H⁺ form of the zeolite.

### DETAILED DESCRIPTION

The present disclosure relates to methods for the preparation of bifunctional catalysts comprising a transition metal supported by a zeolite without any appreciable ion exchange of the transition metal cations with the protons within the zeolite channels. The protons bound to the zeolite acid sites within the zeolite channels are protected from exchange with metal cations by first protecting the zeolite acid sites with protecting cations prior to deposition of the metal. The metal can then be decomposed to a stable oxide, and the protecting cations can subsequently be removed under conditions which do not promote migration of the metal into the zeolite channels.

As used herein, the terms “bifunctional catalyst” and “integral catalyst” refer interchangeably to a catalyst containing at least a catalytically active metal component and a zeolite component.

In some embodiments, the catalysts of the present disclosure are useful as hydrotreating catalysts and contain at least one transition metal component selected from Groups 8-11 of the IUPAC Periodic Table (2011) deposited onto a zeolite component. For example, the transition metal component can be platinum or palladium.

In some embodiments, the catalysts of the present disclosure are hybrid Fischer-Tropsch (FT) catalysts. The phrases “hybrid FT catalyst,” “integral FT catalyst” and “integral synthesis gas conversion catalyst” refer interchangeably to a catalyst containing at least one FT metal component selected from the group consisting of cobalt, iron, ruthenium and mixtures thereof as well as a zeolite component containing the appropriate functionality to convert the primary Fischer-Tropsch products into desired products, i.e., minimize the amount of heavier, C₂₁₊ products. The FT component is preferably cobalt. Thus, the combination of a FT component displaying high selectivity to short-chain α-olefins and oxygenates with a zeolite component, interchangeably referred to as an “acidic component,” results in an enhanced C₅₊ selectivity by promoting combinations of oligomerization, cracking, isomerization, and/or aromatization reactions on the zeolite acid sites. Desired hydrocarbon mixtures, including, for example, diesel range products, can be produced in a single reactor using hybrid FT catalysts by combining a FT component with an acidic zeolite component. Primary waxy products, when formed on the FT component, are cracked/hydrocracked (i.e., by the acidic zeolite component) into mainly branched hydrocarbons with limited formation of aromatics. In particular, the presently disclosed hybrid FT catalyst can be run under certain FT reaction conditions to provide liquid hydrocarbon mixtures or products containing less than about 10 weight % CH₄ and less than about 5 weight % C₂₁₊. The products formed can be substantially free of solid wax, i.e., C₂₁₊ paraffins, by which is meant that there is minimal soluble solid wax phase at ambient conditions, i.e., 20° C. at 1 atmosphere. As a result, there is no need to separately treat a wax phase in hydrocarbons effluent from a reactor.

In the integral FT catalyst according to the present disclosure, the FT metal is distributed as small crystallites on a binder such as alumina in combination with the zeolite component. The FT metal content of the integral FT catalyst can depend on the alumina content of the zeolite. For example, for a binder content of about 20 weight % to about 99 weight % based upon the weight of the binder and zeolite, the catalyst can contain, for example, from about 1 to about 20 weight % FT metal, preferably 5 to about 15 weight % FT metal, based on total catalyst weight, at the lowest binder content. At the highest binder content, the catalyst can contain, for example, from about 5 to about 30 weight % FT metal, preferably from about 10 to about 25 weight % FT metal, based on total catalyst weight. By way of example and not limitation, suitable binder materials include alumina, silica, titania, magnesia, zirconia, chromia, thoria, boria, beryllia and mixtures thereof.

A zeolite is a molecular sieve or crystalline material having regular passages (pores) that contains silica in the tetrahedral framework positions. Examples include, but are not limited to, silica-only (silicates), silica-alumina (aluminosilicates), silica-boron (borosilicates), silica-germanium (germanosilicates), alumina-germanium, silica-gallium (gallosilicates) and silica-titania (titanosilicates), and mixtures thereof. If examined over several unit cells of the structure, the pores will form an axis based on the same units in the repeating crystalline structure. While the overall path of the pore will be aligned with the pore axis, within a unit cell, the pore may diverge from the axis, and it may expand in size (to form cages) or narrow. The axis of the pore is frequently parallel with one of the axes of the crystal. The narrowest position along a pore is the pore mouth. The pore size refers to the size of the pore mouth. The pore size is calculated by counting the number of tetrahedral positions that form the perimeter of the pore mouth. A pore that has 10 tetrahedral positions in its pore mouth is commonly called a 10 membered ring pore. Pores of relevance to catalysis in this application have pore sizes of 8 tetrahedral positions (members) or greater. If a molecular sieve has only one type of relevant pore with an axis in the same orientation to the crystal structure, it is called 1-dimensional. Molecular sieves may have pores of different structures or may have pores with the same structure but oriented in more than one axis related to the crystal.

In the acid form of a zeolite, also referred to as the H⁺ form, the acid sites are formed since a charge balancing cation is needed due the presence of aluminum in the SiO₂ framework. If the cation is a proton, as is the case for suitable zeolites for use in the present method and catalyst, the zeolite will have Bronsted acidity.

Small pore molecular sieves are defined herein as those having 6 or 8 membered rings; medium pore molecular sieves are defined as those having 10 membered rings; large pore molecular sieves are defined as those having 12 membered rings; extra-large molecular sieves are defined as those having 14+ membered rings.

Mesoporous molecular sieves are defined herein as those having average pore diameters between 2 and 50 nm. Representative examples include the M41 class of materials, e.g. MCM-41, in addition to materials known as SBA-15, TUD-1, HMM-33, and FSM-16.

Exemplary medium pore molecular sieves include, but are not limited to, designated EU-1, ferrierite, heulandite, clinoptilolite, ZSM-11, ZSM-5, ZSM-57, ZSM-23, ZSM-48, MCM-22, NU-87, SSZ-44, SSZ-58, SSZ-35, SSZ-46 (MEL), SSZ-57, SSZ-70, SSZ-74, SUZ-4, Theta-1, TNU-9, IM-5 (IMF), ITQ-13 (ITH), ITQ-34 (ITR), and silicoaluminophosphates designated SAPO-11 (AEL) and SAPO-41 (AFO). The three letter designation is the name assigned by the IUPAC Commission on Zeolite Nomenclature.

Exemplary large pore molecular sieves include, but are not limited to, designated Beta (BEA), CIT-1, Faujasite, H-Y, Linde Type L, Mordenite, ZSM-10 (MOZ), ZSM-12, ZSM-18 (MEI), MCM-68, gmelinite (GME), cancrinite (CAN), mazzite/omega (MAZ), SSZ-26 (CON), MTT (e.g., SSZ-32, ZSM-23 and the like), SSZ-33 (CON), SSZ-37 (NES), SSZ-41 (VET), SSZ-42 (IFR), SSZ-48, SSZ-55 (ATS), SSZ-60, SSZ-64, SSZ-65 (SSF), ITQ-22 (IWW), ITQ-24 (IWR), ITQ-26 (IWS), ITQ-27 (IWV), and silicoaluminophosphates designated SAPO-5 (AFI), SAPO-40 (AFR), SAPO-31 (ATO), SAPO-36 (ATS) and SSZ-51 (SFO).

Exemplary extra large pore molecular sieves include, but are not limited to, designated CIT-5, UTD-1 (DON), SSZ-53, SSZ-59, and silicoaluminophosphate VPI-5 (VFI).

The zeolite of the catalysts of the present disclosure may be herein referred to as the “acidic component” which may encompass the above zeolitic materials. The Si/Al ratio for the zeolite can be 10 or greater, for example, between about 10 and 100. The acidic component may also encompass non-zeolitic materials such as by way of example, but not limited to, amorphous silica-alumina, tungstated zirconia, non-zeolitic crystalline small pore molecular sieves, non-zeolitic crystalline medium pore molecular sieves, non-zeolitic crystalline large and extra large pore molecular sieves, mesoporous molecular sieves and non-zeolite analogs.

According to one embodiment, the zeolite is initially in the form of an extrudate comprising zeolite in a binder matrix. Such zeolite materials can be made by known extrusion means or may be purchased. Suitable binder matrix materials useful for forming the extrudate include, for example, solids of alumina, silica, titania, magnesia, zirconia, chromia, thoria, boria, beryllia and mixtures thereof. The zeolite extrudate can have an external surface area of between about 10 m²/g and about 300 m²/g, a porosity of between about 30 and 80%, and a crush strength of between about 1.25 and 5 lb/mm

In one embodiment, a suitable zeolite extrudate is subjected to an initial ion exchange step with a suitable protecting cation to effect ion-exchange of the acidic protons with the protecting cation, thus forming an ion exchanged zeolite extrudate.

Suitable protecting cations include, for example, Na, K, Ca, Li, Rb, Be, Mg, Sr, Ca, Ba and ionic ammonium complexes and mixtures thereof in soluble solution. Solutions of sodium ions are preferred such as may be found as sodium chloride solutions. The solution of the protecting cation will typically be in the range of from about 0.01 M to the limit of solubility, preferably about 0.1 M to about 10 M, more preferably about 0.5 M to about 5 M and most preferably from about 0.5 M to about 1.0 M. Generally, the zeolite and protecting cation(s) are brought into contact in a vessel suitable for this purpose with stirring. Heat may be added as necessary for any suitable length of time to effect the ion exchange of the protecting cation. Most often when heat is employed, less than about 100° C. will be effective. The condition in which this step is carried is not restrictive and a skilled artisan will be able to determine any appropriate conditions to achieve the desired reaction.

In an alternative embodiment, a suitable zeolite extrudate which is already in the ion exchanged form, i.e. in the Na⁺ form, can be obtained commercially, thus obviating the need to conduct the initial ion exchange step in order to protect the acid sites.

Protection of the acid sites on the zeolite is followed by deposition of the transition metal by any suitable technique well known to those skilled in the art so as to distend the metal in a uniform thin layer on the catalyst zeolite support which may include, but not limited to, precipitation, impregnation and the like. For example, a method to deposit the metal onto the zeolite support may involve an impregnation technique using an aqueous or nonaqueous solvent solution containing a soluble metal salt and, if desired, a soluble promoter metal, in order to achieve the necessary metal loading and distribution required to provide a highly selective and active catalyst. For example, for the deposition of cobalt in the preparation of a hybrid FT catalyst, suitable cobalt salts include, but are not limited to, cobalt nitrate, cobalt acetate, cobalt carbonyl, cobalt acetylacetonate, or the like. Suitable promoters include platinum, palladium, rhenium, iridium, silver, copper, gold, manganese, ruthenium and combinations thereof.

In one preferred embodiment, a ruthenium promoter is included with a primary cobalt FT component in the preparation of a hybrid FT catalyst. These catalysts have very high activities due to easy activation at low temperatures. In the preparation of ruthenium promoted catalysts, any suitable ruthenium salt, such as ruthenium nitrate, chloride, acetate or the like can be used. Descriptions of known methods for preparing hybrid FT catalysts including cobalt and ruthenium are described in U.S. Pat. No. 4,088,671to Kobylinski, and U.S. Pat. No. 5,756,419 and U.S. Pat. No. 5,939,350 to Chaumette et al. For a catalyst containing about 10 weight % cobalt, the amount of ruthenium can be from about 0.01 to about 0.50 weight %, for example, from about 0.05 to about 0.25 weight % based upon total catalyst weight. The amount of ruthenium would accordingly be proportionately higher or lower for higher or lower cobalt levels, respectively. A catalyst level of about 10 weight % has been found to best for 80 weight % ZSM-5 zeolite and 20 weight % alumina binder. The amount of cobalt can be increased as amount of alumina increases, up to about 20 weight % cobalt.

The transition metal along with the promoter can be deposited on the zeolite support material by the “incipient wetness” technique for instance. Such technique is well known and requires that the volume of solvent solution be predetermined so as to provide the minimum volume which will just wet the entire surface of the zeolite support, with no excess liquid. Alternatively, the excess solution technique can be utilized if desired. If the excess solution technique is utilized, then the excess solvent present, e.g., acetone, is merely removed by evaporation. Alternatively, vapor deposition or any other suitable means for depositing the transition metal can be used as would be apparent to one skilled in the art.

Suitable solvents include, for example, water; ketones, such as acetone, butanone (methyl ethyl ketone); the lower alcohols, e.g., methanol, ethanol, propanol and the like; amides, such as dimethyl formamide; amines, such as butylamine; ethers, such as diethylether and tetrahydrofuran; hydrocarbons, such as pentane and hexane; and mixtures of the foregoing solvents. For example, the solvents can be acetone or tetrahydrofuran.

Next, the solvent solution and zeolite extrudate can be stirred while evaporating the solvent at a temperature of from about 25° C. to about 50° C. until “dryness.”

The impregnated catalyst is slowly dried at a temperature of from about 110° C. to about 120° C. for a period of about 1 hour so as to spread the metals over the entire zeolite extrudate to form an intermediate integral catalyst. The drying step is conducted at a very slow rate in air.

The dried catalyst, i.e., the intermediate integral catalyst, may be reduced directly in hydrogen or it may be calcined first. A single calcination step to decompose nitrates is simpler if multiple impregnations are needed to provide the desired metal loading. Reduction in hydrogen requires a prior purge with inert gas, a subsequent purge with inert gas and a passivation step in addition to the reduction itself, as described later as part of the activation. However, impregnation of the transition metal salt should be carried out in a dry, oxygen-free atmosphere and it should be decomposed directly, then passivated, if the benefits of its lower oxidation state are to be maintained.

The dried catalyst is calcined by heating slowly in flowing air, for example, about 10 cc/gram/minute, to a temperature between about 100° C. and about 500° C., even in the range of from about 200° C. to about 350° C., for example, from about 250° C. to about 300° C., that is sufficient to decompose the metal salts and fix the metals as metal oxides. The aforesaid drying and calcination steps can be done separately or can be combined. However, calcination should be conducted by using a slow heating rate of, for example, about 0.5° C. to about 3° C. per minute or from about 0.5° C. to about 1° C. per minute and the catalyst should be held at the maximum temperature for a period of about 1 to about 20 hours, for example, for about 2 hours.

The foregoing impregnation steps are repeated with additional substantially aqueous or non-aqueous solutions in order to obtain the desired metal loading. Promoter metal oxides are conveniently added together with the transition metal, but they may be added in other impregnation steps, separately or in combination, either before, after, or between impregnations of transition metal.

Next, a secondary ion exchange step is conducted with an ionic ammonium complex or salt, also referred to herein as simply “ammonium,” to exchange the protecting cations in the zeolite with the ionic ammonium complex to form an NH₄⁺ form of the zeolite. For the purposes of the present disclosure, the secondary ion exchange step encompasses not only an ion exchange process as previously described, involving stirring the zeolite with a cation-containing solution containing the ionic ammonium complex, but also contacting the zeolite with the cation-containing solution containing the ionic ammonium complex by incipient wet impregnation or excess solution such that ion exchange occurs with the cations in the zeolite. Suitable ionic ammonium complexes can be selected from ammonium nitrate, ammonium chloride, ammonium carbonate and the like.

Following the secondary ion exchange step, the ammonium treated catalyst is dried and subjected to heating at a temperature sufficient to decompose the ammonium to ammonia which is released and H⁺, which restores the acidity of the zeolite, i.e. generates the acid or H⁺ form of the zeolite, since a cation is required for each aluminum atom for charge balance. This temperature can be less than about 500° C., even between about 350° C. and 500° C.

In an alternative embodiment, the protecting cation used is ammonium. Thus, the initial ion exchange step occurs by exchanging ammonium cations with the zeolite extrudate protons. In this embodiment, following the transition metal deposition and drying, the intermediate integral catalyst is subjected to mild heat treatment at a temperature less than about 500° C., even between about 350° C. and 500° C., upon which the ammonium decomposes to ammonia and H⁺. Again, the decomposition of ammonium converts the zeolite back to the acid or H⁺ form of the zeolite. In this embodiment, advantageously, no secondary ion exchange step is required.

While the above methods have assumed starting with the zeolite in the form of an extrudate comprising zeolite in a matrix of binder, the scope of the present disclosure includes alternative methods for forming the catalyst. For example, according to one embodiment, the initial form of the zeolite can be a powder. The zeolite powder can be subjected to an initial ion exchange step, or a commercial zeolite already in the Na⁺ form can be obtained. To this can be added the transition metal (with optional promoters) deposited onto a binder material. Suitable binder materials have previously been described. Suitable methods for depositing the metal onto the binder material are the same as those described for depositing the metal onto a zeolite extrudate, i.e., by wet impregnation, excess solution or vapor deposition techniques and the like. The combination of ion exchanged zeolite powder and metal/binder can then be formed into an integral catalyst by extrusion.

According to yet another embodiment, the transition metal can be deposited directly onto a zeolite powder by any of the previously described deposition methods, and the resulting metal/zeolite particles can be combined with a binder matrix and formed into an integral or bifunctional catalyst by extrusion.

Integral or bifunctional catalysts prepared according to any of the methods disclosed herein maintain full zeolite acidity after transition metal deposition with the metal highly dispersed and of optimum particle size for good catalytic activity. Substantially all of the metal is in the form of reduced crystallites of metal located outside the zeolite channels with little or none of the metal located within the zeolite channels. No appreciable ion exchange of the metal therefore occurs within the zeolite channels. As a result, the percentage of residual acid sites is at least about 50%, even at least about 80%, even at least about 90%, even at least about 95% and even about 100%. As defined herein, “percentage of residual acid sites” refers to the percentage of acidity of the integral catalyst as measured by FTIR spectrometer in μmol Bronsted acid sites per gram zeolite relative to the acidity of the zeolite component used in the integral catalyst having no additional components thereon. In other words, the acid site density of the integral catalyst as measured by FTIR spectrometer in μmol Bronsted acid sites per gram is at least about 50%, even at least about 80%, even at least about 90%, even at least about 95% and even about 100% of the acid site density of the zeolite component used in the integral catalyst having no additional component. The high percentage of residual acid sites allows for maximum utilization of metal for catalytic activity, since any metal that exchanges will not be available for catalysis. No separate, undesirable aluminate phase is formed.

The integral catalyst prepared according to any of the foregoing methods can optionally be further activated prior to use in a synthesis gas conversion process by either reduction in hydrogen or successive reduction-oxidation-reduction (ROR) treatments. The reduction or ROR activation treatment is conducted at a temperature considerably below about 500° C. in order to achieve the desired increase in activity and selectivity of the integral catalyst. Temperatures of 500° C. or above reduce activity and liquid hydrocarbon selectivity of the catalyst. Suitable reduction or ROR activation temperatures are below 500° C., preferably below 450° C. and most preferably, at or below 400° C. Thus, ranges of about 100° C. or 150° C. to about 450° C., for example, about 250° C. to about 400° C. are suitable for the reduction steps. The oxidation step should be limited to about 200° C. to about 300° C. These activation steps are conducted while heating at a rate of from about 0.1° C. to about 5° C., for example, from about 0.10° C. to about 2° C.

The catalyst can be slowly reduced in the presence of hydrogen. If the catalyst has been calcined after each impregnation, to decompose nitrates or other salts, then the reduction may be performed in one step, after an inert gas purge, with heating in a single temperature ramp (e.g., 1° C./min.) to the maximum temperature and held at that temperature, from about 250° C. or 300° C. to about 450° C., for example, from about 350° C. to about 400° C., for a hold time of 6 to about 65 hours, for example, from about 16 to about 24 hours. Pure hydrogen is preferred in the first reduction step. If nitrates are still present, the reduction is preferably conducted in two steps wherein the first reduction heating step is carried out at a slow heating rate of no more than about 5° C. per minute, for example, from about 0.1° C. to about 1° C. per minute up to a maximum hold temperature of about 200° C. to about 300° C., for example, about 200° C. to about 250° C., for a hold time of from about 6 to about 24 hours, for example, from about 16 to about 24 hours under ambient pressure conditions. In the second treating step of the first reduction, the catalyst can be heated at from about 0.5° C. to about 3° C. per minute, for example, from about 0.1° C. to about 1° C. per minute to a maximum hold temperature of from about 250° C. or 300° C. up to about 450° C., for example, from about 350° C. to about 400° C. for a hold time of 6 to about 65 hours, for example, from about 16 to about 24 hours. Although pure hydrogen is preferred for these reduction steps, a mixture of hydrogen and nitrogen can be utilized.

Thus, the reduction may involve the use of a mixture of hydrogen and nitrogen at about 100° C. for about one hour; increasing the temperature about 0.5° C. per minute until a temperature of about 200° C.; holding that temperature for approximately 30 minutes; and then increasing the temperature about 1° C. per minute until a temperature of about 350° C. is reached and then continuing the reduction for approximately 16 hours. Reduction should be conducted slowly enough and the flow of the reducing gas maintained high enough to maintain the partial pressure of water in the offgas below 1%, so as to avoid excessive steaming of the exit end of the catalyst bed. Before and after all reductions, the catalyst should be purged in an inert gas such as nitrogen, argon or helium.

The reduced catalyst can be passivated at ambient temperature (about 25° C. to about 35° C.) by flowing diluted air over the catalyst slowly enough so that a controlled exotherm of no larger than +50° C. passes through the catalyst bed. After passivation, the catalyst is heated slowly in diluted air to a temperature of from about 300° C. to about 350° C., preferably 300° C., in the same manner as previously described in connection with calcination of the catalyst.

The temperature of the exotherm during the oxidation step should be less than about 100° C., and will be about 50° C. to about 60° C. if the flow rate and/or the oxygen concentration are dilute enough.

Next, the reoxidized catalyst is then slowly reduced again in the presence of hydrogen, in the same manner as previously described in connection with the initial reduction of the catalyst. Since nitrates are no longer present, this reduction may be accomplished in a single temperature ramp and held, as described above for reduction of calcined catalysts.

### EXAMPLES

The methods and catalysts of the present disclosure will be further illustrated by the following examples, which set forth particularly advantageous method embodiments. While the Examples are provided to illustrate the invention, they are not intended to limit it. This application is intended to cover those various changes and substitutions that may be made by those skilled in the art without departing from the spirit and scope of the present disclosure.

### Analytical Methods

Zeolite Acidity was measured using a Nicolet 6700 FTIR spectrometer with MCT detector (available from Thermo Fisher Scientific Inc.). Materials were pressed into self supporting wafers (about 5 to about 15 mg/cm²) and degassed by heating under vacuum at about 1° C./min to about 350° C. and held at that temperature for about 1 hr before measuring spectra at about 80° C. in transmission mode. Spectra were recorded with 128 scans from about 400 to about 4000 cm⁻¹ with a resolution of about 4 cm⁻¹. Total acidity was estimated using the integrated area of acidic OH resonance centered near 3610 cm⁻¹ and correcting for the pellet weight and Co concentration.

Percentage of Residual Acid Sites was calculated by dividing the acidity measurement of an integral FT catalyst sample by the acidity measurement of the zeolite component having no additional component, i.e., no FT metal component, thereon. In other words, percentage of residual acid sites is the percentage of retained acidity in the integral catalyst relative to the zeolite. For example, an extrudate consisting of about 80 wt % H-ZSM-5 and about 20 wt % Al₂O₃ would have an acidity of 100%. A cobalt exchanged catalyst prepared on this support would have an acidity of 100% if it retained all of the acid sites. The error for this measurement is less than 10% absolute.

### Example 1

A zeolite extrudate was obtained from Zeolyst International, Conshohocken, Pa. (CBV-8014) containing about 80 wt % H-ZSM-5 and about 20 wt % Al₂O₃ and having 252 μmol Bronsted acid sites per gram of zeolite. The extrudate was ion-exchanged twice with sodium cations. Each ion exchange used 10 g extrudate that was stirred in a 0.5 M aqueous NaCl solution at about 80° C. for about 1 hr. The zeolite was filtered and washed with 2 L of deionized water after each exchange. A cobalt solution was prepared by dissolving about 15.07 g Co(NO₃)₂ 6H₂O in about 20 g deionized water. The zeolite containing sodium cations was dried in a box furnace at about 120° C. with flowing dry air. It was impregnated with the above solution by adding about 2.04 g dropwise to about 3.94 g zeolite extrudate. The material was then heated to about 120° C. in air at about 1° C./min and held at that temperature for about 1 hr, then heated to about 350° C. at about 2.3° C./min and held at that temperature for about 5 hr. The cobalt impregnated extrudate was then ion-exchanged with about 0.5 M aqueous NH₄NO₃ solution at about 80 ° C. for about 1.5 hr. Next the material was heated to about 120° C. in air at about 1° C./min and held at that temperature for about 1 hr, then heated to about 500° C. at about 1° C./min and held at that temperature for about 5 hr. The acidity measurement and percentage residual acid sites are shown in Table 1.

### Example 2

The Co impregnated zeolite from Example 1, after the first ion exchange with about 0.5 M aqueous NH₄NO₃, was ion exchanged two more times with about 0.5 M aqueous NH₄NO₃ at 80° C. Next the product was heated to about 120° C. in air at about 1° C./min and held at that temperature for about 1 hr, then heated to about 500° C. at about 1° C./min and held at that temperature for 5 hr. The acidity measurement and percentage residual acid sites are shown in Table 1.

### Example 3

A zeolite extrudate was obtained from Zeolyst International (CBV-8014) that contained about 80% H-ZSM-5 and about 20% Al₂O₃. The extrudate was ion-exchanged three times with ammonium cations. Each ion exchange uses 10 g extrudate that is stirred in a 0.5 M aqueous NH₄NO₃ solution at about 80° C. for about 1 hr. The zeolite was filtered and washed with 2 L of deionized water after each exchange. A cobalt solution was prepared by dissolving about 15.07 g Co(NO₃)₂ 6H₂O in about 20 g deionized water. The zeolite containing ammonium cations was dried in a box furnace at about 120° C. with flowing dry air. It was impregnated with the above solution by adding about 2.3 g dropwise to about 4 g zeolite extrudate. The material was then heated to about 120° C. in air at about 1° C./min and held at that temperature for about 1 hr, then heated to about 350° C. at about 2.3° C./min and held at that temperature for about 5 hr. The acidity of the resulting material was measured using FTIR and the results are shown in Table 1.

### Comparative Example

A cobalt solution was prepared by dissolving about 15.07 g Co(NO₃)₂ 6H₂O in about 20 g deionized water. A zeolite extrudate was obtained from Zeolyst International (CBV-8014) that contained about 80 wt % H-ZSM-5 and about 20 wt % Al₂O₃. The zeolite was dried in a box furnace at about 120° C. with flowing dry air. The support was impregnated with the above solution by adding about 1.45 g dropwise to about 2.87 g zeolite extrudate. The product was then heated to about 120° C. in air at about 1° C./min and held at that temperature for about 1 hr, then heated to about 350° C. at about 2.3° C./min and held at that temperature for about 5 hr. The acidity measurement and percentage residual acid sites are shown in Table 1.

TABLE 1

| | Acidity measurement, | |
|---|---|---|
| | μmol Bronsted acid sites | % Residual |
| Sample | per gram zeolite | Acid Sites |
| Example 1 | 204 | 81 |
| Example 2 | 224 | 89 |
| Example 3 | 189 | 75 |
| Comparative Example | 156 | 62 |

Where permitted, all publications, patents and patent applications cited in this application are herein incorporated by reference, to the extent such disclosure is not inconsistent with the present invention.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

From the above description, those skilled in the art will perceive improvements, changes and modifications, which are intended to be covered by the appended claims.

What is claimed is:

1. A method for preparing a catalyst comprising:
a. conducting ion exchange of a zeolite with an ammonium cation to form an ion exchanged zeolite;
b. depositing a catalytically active component comprising a transition metal onto the ion exchanged zeolite to form an intermediate integral catalyst; and
c. heating the intermediate integral catalyst at sufficient temperature to decompose the catalytically active component and generate the H⁺ form of the zeolite.

2. A method for preparing a catalyst comprising:
a. conducting initial ion exchange of a zeolite with a cation selected from the group consisting of Group 1, Group 2, and ammonium cations and mixtures thereof to form an ion exchanged zeolite;
b. depositing a catalytically active component comprising a transition metal onto the ion exchanged zeolite to form an intermediate integral catalyst;
c. heating the intermediate integral catalyst at sufficient temperature to decompose the catalytically active component;
d. conducting secondary ion exchange of the intermediate integral catalyst with ammonium to form an ammonium treated catalyst wherein ammonium ions exchange with the cation of the ion exchanged zeolite; and
e. heating the ammonium treated catalyst at sufficient temperature to decompose the ammonium to ammonia and generate the H⁺ form of the zeolite.

3. The method of claim 1 or claim 2, wherein the catalytically active component comprises a Fischer-Tropsch metal selected from the group consisting of cobalt, iron, ruthenium and mixtures thereof.

4. The method of claim 1 or claim 2, wherein the catalytically active component comprises a metal selected from the group consisting of Group 8, Group 9, Group 10, and Group 11 metals.

5. The method of claim 1 or claim 2, wherein the catalytically active component comprises a metal selected from the group consisting of platinum and palladium.

6. The method of claim 1 or claim 2, wherein the zeolite is in the form of an extrudate.

7. The method of claim 1 or claim 2, wherein the intermediate integral catalyst is heated to a temperature between about 100° C. and about 500° C.

8. The method of claim 3, wherein the Fischer-Tropsch component comprises cobalt.

9. The method of claim 3, wherein the Fischer-Tropsch component further comprises a promoter selected from the group consisting of platinum, palladium, rhenium, iridium, silver, copper, gold, manganese, ruthenium and combinations thereof.

10. The method of claim 2, wherein the cation is selected from the group consisting of Na, K, Ca, Li, Rb, Be, Mg, Sr, Ca, Ba and ammonium cations and mixtures thereof.

11. The method of claim 2, wherein the cation comprises sodium.

12. The method of claim 2, wherein the step of heating the ammonium treated catalyst occurs at a temperature between about 350° C. and about 500° C.

13. The method of claim 1 or claim 2, wherein the catalytically active component is deposited onto the zeolite by a method selected from the group consisting of incipient wet impregnation, excess solution and vapor deposition.

14. The method of claim 1 or claim 2, further comprising activating the integral synthesis gas conversion catalyst by reduction in hydrogen or by successive reduction-oxidation-reduction treatments.

15. An integral synthesis gas conversion catalyst prepared according to the method of claim 1 or claim 2.

16. An integral synthesis gas conversion catalyst comprising:
a Fischer-Tropsch component selected from the group consisting of cobalt, iron, ruthenium and mixtures thereof, a zeolite component and a binder;
wherein the acid site density of the integral synthesis gas conversion catalyst is at least about 50% of the acid site density of the zeolite component having no additional component.

17. The integral synthesis gas conversion catalyst of claim 16, wherein the acid site density of the integral synthesis gas conversion catalyst is at least about 80% of the acid site density of the zeolite component having no additional component.

18. The integral synthesis gas conversion catalyst of claim 16, wherein the acid site density of the integral synthesis gas conversion catalyst is at least about 90% of the acid site density of the zeolite component having no additional component.

19. The integral synthesis gas conversion catalyst of claim 16, wherein the acid site density of the integral synthesis gas conversion catalyst is about 100% of the acid site density of the zeolite component having no additional component.
